(19) United States
(12) Patent Application Publication
(10) Pub. No.: US 2012/0030187 A1
(43) Pub. Date: Feb. 2, 2012

(54) SYSTEM, METHOD AND APPARATUS FOR TRACKING DIGITAL CONTENT OBJECTS

(76) Inventors: Robert F. MARANO, Bedford, NY (US); Christopher W. WHIDDEN, Seaford, NY (US); Daniel POHL, New York, NY (US)

(21) Appl. No.: 13/185,192

(22) Filed: Jul. 18, 2011

Related U.S. Application Data
(63) Continuation-in-part of application No. 12/429,791, filed on Apr. 24, 2009.
(60) Provisional application No. 61/047,453, filed on Apr. 24, 2008.
(60) Provisional application No. 61/047,572, filed on Apr. 24, 2008.

(51) Int. Cl. G06F 17/30

(52) U.S. Cl. 707/709; 707/E17.014

(57) ABSTRACT

A system and method for secure document management including tagging and/or remotely tracking documents exchanged between one or more users and a document repository. In some embodiments, the security policies for documents are determined based at least in part on document content, metadata associated with the document, and/or usage history of the document.

### CROSS-REFERENCE TO RELATED APPLICATIONS

This application is a continuation-in-part application of U.S. patent application Ser. No. 12/429,791, filed Apr. 24, 2009, which in turn claims benefit of both U.S. Provisional Patent Application Ser. No. 61/047,453 filed on Apr. 24, 2008, entitled “System, Method and Apparatus for Assuring Authenticity and Permissible Use of Electronic Documents” and U.S. Provisional Patent Application Ser. No. 61/047,572, filed on Apr. 24, 2008, entitled “System, Method and Apparatus for remote tracking of enterprise documents,” the entirety of which are incorporated herein by reference.

### FIELD OF THE INVENTION

Embodiments of the present invention relate to network security, document security and, more particularly, to a system, method and apparatus for document security and authenticity assurance of documents, for example, by tagging and/or tracking.

### BACKGROUND OF THE INVENTION

In a network where documents are shared among multiple users, document security is critically important. Current document security platforms typically secure documents by designating specific restricted server locations to store confidential or high security documents, while designating other less restricted server locations to store less restricted documents. Access to the restricted server locations is typically limited only to authorized users. These documents are thereby protected. However, when a document designated to an unrestricted server location is modified, for example, by adding confidential information, this confidential information is then saved in an insecure server location and may be vulnerable to misuse. Accordingly, there is a need for a security platform to dynamically secure documents based on changing content.

In addition, in a large-scale network, for example, for enterprises, such as, corporate, financial, educational and other organizations, a large number of documents are typically shared by many users. A breach of security, for example, a corruption of a single confidential file, may be difficult to detect among the volume of documents in the network. Furthermore, if the security breach is detected, it may be impossible to discover with certainty the individual user responsible for the breach from among the many users that can access the file. Accordingly, there is a need for a security platform to detect document misuse and/or to identify one or more users responsible for the misuse.

Regarding authenticity, due to the volume and diversity of files typically stored in large-scale network servers, including text, word processing documents, spreadsheets, databases, image files, audio and video files, etc., it may be impractical to individually monitor each modified version of a document to verify that the document is authentic. Accordingly, there is a need for keeping track of documents checked out and in to the system for purposes of user authorization to perform certain tasks and document authentication for enterprise documents.

### SUMMARY OF THE INVENTION

Some embodiments of the invention include a system and method for secure document management, comprising: receiving a request by a user to download a document, the user being associated with a user security parameter, and the document being associated with a document security parameter; determining whether to permit the request by comparing the user security parameter with the document security parameter; and if the request to download is permitted based on the determination, then modifying the document by embedding a security tag therewithin, and providing the user with the modified document. In some embodiments of the invention, the document security parameter may be associated with the document based on at least one of a plurality of properties of the document, the properties including the content of the document, metadata associated with the document, and usage history of the document.

Some embodiments of the invention include a system and method for secure document management, comprising: receiving a request by a user to upload a document; retrieving from the document a security tag embedded therewithin; determining whether to permit with the request based at least in part on the security tag; and if the request to upload the document is permitted, then modifying the document by removing the security tag from the document, and storing the modified document. In some embodiments of the invention, if the request to upload the document is permitted, then the method and system are to evaluate a document security parameter for the document based on at least one of a plurality of properties of the document, the properties including the content of the document, metadata associated with the document, and usage history of the document.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanied drawings in which:

FIG. 1 is a schematic illustration of a computer network according to some embodiments of the present invention;

FIG. 2 is a schematic illustration of a graphical user interface according to some embodiments of the present invention;

FIG. 3 is a flow diagram of a method according to some embodiments of the present invention;

FIG. 4 is a schematic illustration of a document permission tag according to some embodiments of the present invention;

FIG. 5 is a schematic illustration of a security server according to embodiments of the present invention; and

FIG. 6 is a schematic illustration of applications interfacing with the computing network of FIG. 1 according to embodiments of the present invention.

It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details and that generalization for different programming languages, hardware architectures, operating systems, and resources is possible. In other instances, well-known methods, procedures, components, and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers, or other such information storage, transmission, or display devices. In addition, the term “plurality” may be used throughout the specification to describe two or more components, devices, elements, parameters, or the like.

The term “computer” or “computing device” may be a personal computer, a desktop computer, a mobile computer, a laptop computer, a set-top box, a notebook computer, a workstation, a server computer, a tablet computer, a network appliance, personal digital assistant (PDA), mobile phone, or any other suitable computing device. Typically, a computer includes or is operatively connected to means for connecting the computer to another computer via a network, for example, the Internet.

It should be appreciated that according to some embodiments of the present invention, operations described below may be implemented as machine-executable instructions. These instructions may be used to cause a general-purpose or special-purpose processor using associated software modules programmed with the instructions to perform the operations described. Alternatively, the operations may be performed by specific hardware that may contain hardwired logic for performing the operations, or by any combination of programmed computer components and custom hardware components.

Unless explicitly stated, the method embodiments described herein are not constrained to a particular order or sequence. Additionally, some of the described method embodiments or elements thereof can occur or be performed at the same point in time.

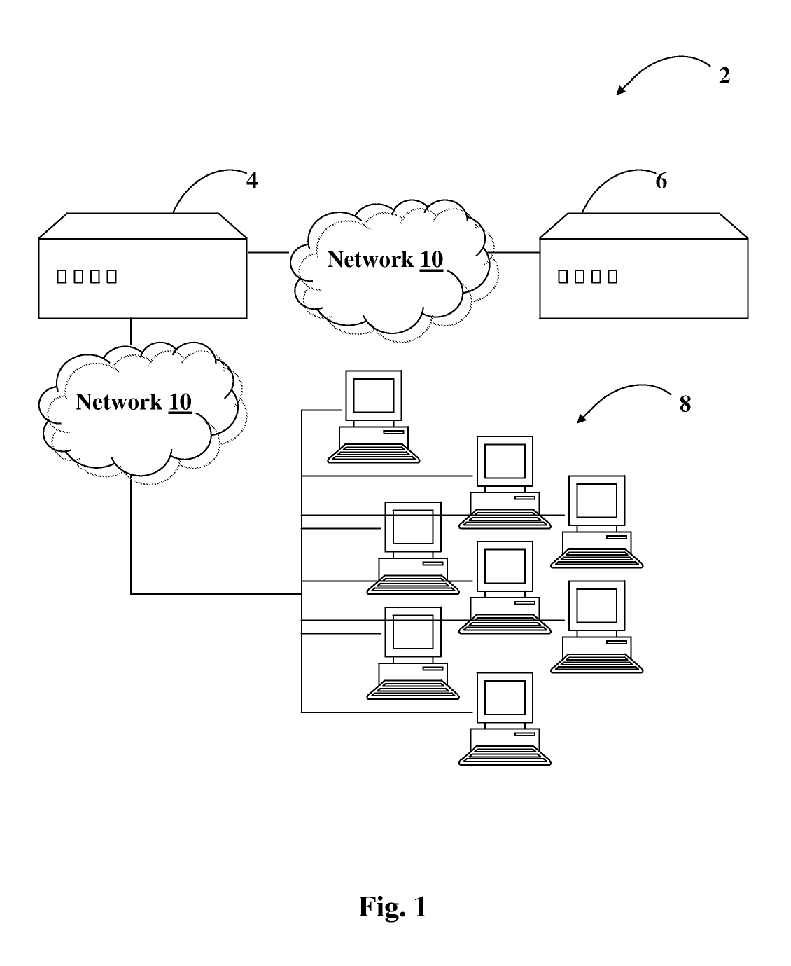

Reference is made to FIG. 1, which is a schematic illustration of a computer network 2, including one or more shared document server(s) 6 accessible over a network 10 by one or more user computers 8. According to an embodiment of the present invention, there is provided one or more security server(s) 4. Security server 4 may act as an intermediary or gatekeeper between shared document server 6 and users and/or user computers 8, which according to embodiments of the invention, may conduct security tests and enforce security policies on documents uploaded/downloaded between shared document server 6 and user computers 8. As described below, according to some embodiments of the invention, security server 4 may be the exclusive means of access of user computers 8 to data and files located or stored on shared document server 6. It will be recognized that FIG. 1 and the following descriptions are schematic in nature, and that security server 4 and shared document server 6 may include one or more components. For example, shared document server 6 may include a plurality of drives or other file repositories, and security server 4 may be a plurality of security servers working together to mediate between shared document server and user computers 8. In another embodiment of the present invention, shared document server 6 may be any suitable shared document environment, for example, a collaborative server environment, e.g., a wild (“what I know is”), a document management server, etc.

Shared document server 6 may be any device capable of receiving, storing and retrieving documents, data, files, etc. and/or information related thereto. Documents on shared document server 6 may typically be electronic documents and/or digitized representations of tangible objects, such as photographs of articles or printed paper documents. The electronic documents stored on shared document server 6 may be received from any input means, including users typing data into a keyboard associated with user computers 8, or by an input means capable of converting physical documents to digitized files by a tangible process, e.g., by scanning physical documents using a scanner, etc.

The documents on shared document server 6 may be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

Documents on shared document server 6 accessible to user computers 8 may include confidential content. According to embodiments of the invention, security server 4 may analyze the contents of documents to determine a document security level. According to an embodiment of the invention, security server 4 may determine and assign a document security level to each document on shared document server 6. As described in further detail below, security server 4 may determine the document security level based at least in part on the contents of the document. Optionally, security server 4 may determine the document security level based on additional document parameters, such as a usage history of the document and/or a storage location of the document. It will be recognized that security server 4 may determine the document security level based on any combination of one or more of the methods described herein. It will be recognized that security server 4 and shared document server 6 may be operationally connected in any number of ways consistent with the teachings of the present invention. For example, in one embodiment of the invention, security server 4 may be a proxy for shared document server 6. Security server 4 may be an appliance server operationally connected to shared document server 6. In one embodiment of the invention, security server 4 may be embedded in shared document server 6 as a monitoring and control process to provide a single comprehensive secured file server, in which case, security server 4 may comprise software and/or hardware modules in the shared document server 6 implementing one or more of the functionalities of security server 4 described herein.

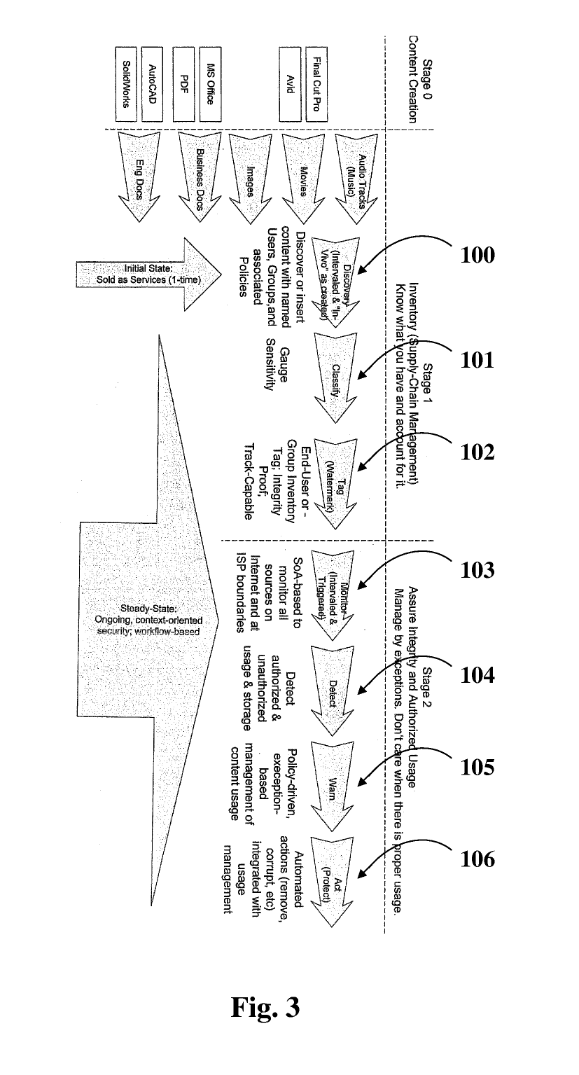

A security server 4 may operate in at least two phases. In an initial “discovery” phase, the security server 4 may populate the document security level for each document in the shared document server 6 by scanning every document therein and assigning a security level for each document based on a set of document security rules. According to one embodiment, such an initialization may begin by assigning a confidential security level to each document unless otherwise modified. The individual documents may then be scanned and evaluated based on content using document security rules. Such document security rules may be established by an administrator and/or may be included in a library of rules applicable to the type of security challenges of an organization. Rules may evaluate document content based on any criteria, for example, text strings, keywords, text patterns, numerical patterns, alphanumeric patterns including all characters, including symbols, general document patterns, and/or logic rules combining these rules, for example, using AND, OR, NOR, XOR, NOT operations, etc. For example, a financial services company may define as confidential all documents having credit card numbers, which may be defined accordingly, etc. Document security levels may be implemented in any number of ways, for example, as a scalar, e.g., on a scale from 0 to 10, or as a plurality of scalars, e.g., four binary bits to denote presence of customer names, phone numbers, credit card numbers, and currency amounts, respectively. Further description of classification is provided below in connection with FIG. 3.

The content of documents in shared document server 6 may continually change by modifications of user computers 8 having permission to access and modify the documents. Accordingly, the document policy setting may be iteratively or repeatedly updated, for example, each time a document is requested from, downloaded from and/or uploaded to shared document server 6. At each instance, the document security level of the document may be established based on the most recently modified version of the document available. Thus, for example, if a document designated as restricted based on confidential content is downloaded to a user, and the document is modified to delete the confidential content, then upon being uploaded to the shared document server 6, the content may be evaluated and the document security level modified to be unrestricted.

Accordingly, in a second “ongoing” phase, after the population of the appropriate security levels for every document in shared document server 6, documents may be evaluated for an updated security level, based at least in part on their content at certain times, for example, upon being uploaded to or downloaded from the system by a user computer 8, upon modification of their content, etc. One parameter of the security level of a document may be the times or frequency with which the security level of the document is to be updated.

Each user and/or user computer 8 may have a user security level. The user security level may include any restriction or permission on a user and/or user computer 8. A user may be identified, for example, by a username and/or password upon logging into the network to obtain access to or to request documents from shared document server 6. In some embodiments, the computer on which a user is operating may be assigned a security level, such that a user logging into the network from a shared computer may be assigned a certain security level indicating a restricted set of permissions, whereas the same user logging in from a private computer, which may be identified by a file stored on the private computer, may have a different, e.g., less restricted, security level. It will be recognized that FIG. 1 and this description are schematic in nature and that users and/or user computers 8 may be implemented in any number of ways. In addition, a user, as used in the present description need not necessarily be a human user, but may be an application operating to retrieve and modify documents from shared document server 6, which application may operate automatically without human user intervention.

A user computer security level may include a Computer Settings which may include set of restrictions or settings that define the permissions and/or restrictions on any or each of user computers 8 in computing network 2. A user security level may include a User Settings which may define the permissions and/or restrictions for any or each of users in computer network 2. A user and/or user computer security level may define the ability of a user and/or user computer 8 to use or not to use a subset of documents in a manner according to the capability options of an operating system. The details of the user and/or user computer security level may be stored on security server 4 and/or cached locally on the respective user computers 8. A user and/or user computer security level may be implemented in any number of ways, for example, as a scalar, e.g., on a scale from 0 to 10, or as a plurality of scalars, e.g., four binary bits to denote permission to receive customer names, phone numbers, credit card numbers, and currency amounts, respectively. Data comprising user and/or user computer security levels may be stored in any storage or memory operatively associated with security server 4, for example, on an lightweight directory access protocol (LDAP) server or active directory server (not shown).

All communication and exchange of documents, data, files, etc. between shared document servers 6 and user computers 8 may be mediated by security server 4. For each document in shared document server 6, security server 4 may store or be operatively associated with storage including the details of the corresponding document security level, document policy setting and/or data associated therewith. The data may be stored or be operatively associated with storage including “permission tags”. Security server 4 may contain or be operatively associated with per-user information, permissions, and settings for all the hardware, operating system software, most non-operating system software, relating to documents in shared document server 6.

As described further below, these parameters may be used in determining whether or not to grant a request by a user on a user computer for an action on a particular document, and moreover, if permission for the action is granted, these parameters may determine conditions placed on such action. In a demonstrative embodiment, a user and/or user computer 8 may send a request to security server 4 to retrieve or download a particular document from shared document server 6. The request may indicate, or the security server 4 may determine based on the request, the user security level of the user and/or user computer 8.

Security server 4 may compare or otherwise match the document security level of the document content with the user security level of the user and/or user computer 8. The matching or comparison may be implemented in any number of ways, for example, by comparing a scalar document security level to a scalar user security level, or by performing a plurality of logical operations on the corresponding scalars of the document security level and the user security level, e.g., if user has no permission to receive credit card numbers and document includes credit card numbers, deny request. In some embodiments of the invention, document security policy may be determined at the time of a request for access to a document by a user by combining and processing information about the document download request transaction, including: content of the document, metadata associated with the document, usage history parameter related to the document, usage history by the user of the present document and/or other documents, e.g., similarly classified documents, classification of the document, and/or properties of the user computer, e.g., location of the user's computer. It will be recognized that for purposes of efficiency, some or all of the determination of a document security policy based on user and/or user computer security level and document security level may be made in advance of the actual request, e.g., at start-up of the security server, and periodically updated. In such an embodiment of the invention, the suitable document security policy need not be calculated with each request, but may be retrieved at the time of the request, e.g., from a look-up table (LUT), or other memory location.

Based on the comparison, security server 4 may decide to grant the request, and may assign the document a corresponding document policy setting, which may establish conditions or restrictions on the request. Thus, each document policy setting may be specific to the content of the document at the time of the request, and the security clearance of an individual user or user computer 8 to view that content. Examples of permissions or restrictions in a document policy setting may include, for example, granting or denying permission to access document, permission to modify document, permission to print document, permission to forward the document, etc. Establishment of other restrictions based on the comparison may trigger actions by the security server 6, or a module associated therewith, to take certain actions prior or after providing the document, e.g., password protect document, tag document, remotely track document, place time restriction on document, etc.

Security server 4 thereby provides document security platform that is user and content specific, and that may dynamically update document security based on continually changing content of the data on shared document server 6 to maintain an accurate and current content- specific security standard. This security platform may therefore ensure document integrity for documents in shared document server 6.

Once a document is downloaded from shared document servers 6 to an individual user computer 8, further measures may be taken to maintain network security. For example, if a user received a document in access only mode, and the user attempts to upload the document into shared document server 6 after making modifications, security server 4 may ascertain that changes were made and may deny the request to upload the document. An alert may be raised to the security administrator. In some embodiments of the invention, the permission may be to modify the document, but not certain restricted content. Thus, for example, a user may receive a document with permission to modify the document, but not to modify certain content. For example, a user may have permission to make formatting modifications to a financial document and not have permission to modify the financial information in the document. Accordingly, when a user uploads a document to the shared document server 6, the security server 4 may compare the document as it was downloaded by the user against the document as it is requested to be uploaded by the user, and determine whether modifications (if any) were made consistently with the document security policy restrictions placed on the document at the time it was downloaded. In another example, if a document security policy did not permit forwarding, then the security server 4 may prohibit the document from being uploaded by any different user than the one to whom it was downloaded. It will be recognized that the document security policy may be determined in any number of ways at the time of upload request, for example, retrieved from storage, recalculated at the time of upload request, retrieved from an embedded tag in the document, etc. Such evaluation may be made at the same time as the updated document security level determination for the uploaded document, as described above. In yet another example, if the document security policy required the document to be uploaded back to the system within a predetermined time, a violation may be determined based on failure to upload the document by that predetermined time, or a reminder may be sent to the user to upload the document, etc. Violations of security policy may be reported to a security administrator.

In one embodiment of the present invention, some document policy settings may require the security server to perform actions on the document prior to being downloaded to the user. For example, the “password protect” policy setting may mandate that the security server 4, or a module associated therewith, automatically modify the document so as to require a password to open the document. A password insertion module may be specific to the file format. Thus, for example, a Microsoft Word document may be passed to a Microsoft Word module that opens the document, inserts a requested password, and returns the password-protected document for downloading by the user. For example, the password may be a pre-stored password associated with the user checking out the document at his request, or it may be the user's network password, or it may be a one-time-use password communicated to the user automatedly via another channel, e.g., email, etc. It will be recognized that principles of the present invention may be implemented in connection with a digital rights management (DRM) system. For example, the shared document server 6 may be a DRM server containing, storing, or otherwise linking to content to distributed to users as protected or restricted content. Accordingly, security server 4 may coordinate encryption of the provided content or document with the DRM server prior to providing content to a user, in accordance with principles of the present invention. Thus, for example, a determined document security policy may direct or instruct a DRM server to encrypt, password-protect, or otherwise restrict content by implementation of capabilities of the DRM server.

In an embodiment of the invention, the security server 4 may tag a document prior to downloading it to a user. The system may tag documents in every instance, or it may do so only in selected instances, for example, based on the comparison of a user security level with a document security level, or based on the document security policy established, as described above. The “tag document” policy setting may be a security platform to track and tag documents for detecting document misuse and for identifying the individual user and/or user computer 8 responsible for the misuse. According to an embodiment of the invention, security server 4 may receive a user request for a document located in shared document server 6. Security server 4 may compare the user security level and the document security level located. If the request is permitted based on the comparison, then security server 4 may mark, tag or otherwise modify the native document by embedding data within the document. The tag may include a unique document identification, the identity of the user to whom the document was downloaded, a usage history parameters related to a usage of the document, e.g., a log of all usage of the document prior to being downloaded, a document hash code, a security level of the document, a document security policy of the document at the time it was downloaded, etc. It will be recognized that according to embodiments of the invention, documents may be stored in the document repository without such tags, or with minimal tags, and that tags may be inserted into the document upon being downloaded to a user.

The tag or data embedded in the tagged document may be signed or encrypted. The tag may be placed into the metadata of a document, such that it may not be visible to a user opening the document in the native application. In some embodiments of the invention, only security server 4 may have the code to decrypt the embedded data, for example, by a decoder module. The security server may reject attempts to upload documents that were downloaded with a tag if the uploaded document has not tag or contains a tag that has been tampered with.

Therefore, when user computer 8 attempts to upload a tagged document into shared document server 6 after making suspect changes, the tagged document may be held and reported to a network administrator for investigation. Suspect changes may include, for example, unauthorized modifications, a tampered tag, etc.

In cases where a document of uncertain origin is presented to the system, for example, by a user, or by an outside party, authenticity of the document, and other information, may be established by analyzing the tag. The network administrator may use security server 4 to decrypt the embedded data of the tag, which may reveal a document activity log showing the time, date, and user to whom the document was downloaded, to what IP address, and under what policy restrictions. The administrator may thereby identify the last known user to receive the document. In addition, where the tag contains a unique document identification number, the document presented may be compared against the document as it was last downloaded and its authenticity and/or accuracy established.

If the document modifications are not suspect, security server 4 may remove the embedded data and restore and upload the document in its native form to the shared document server 6.

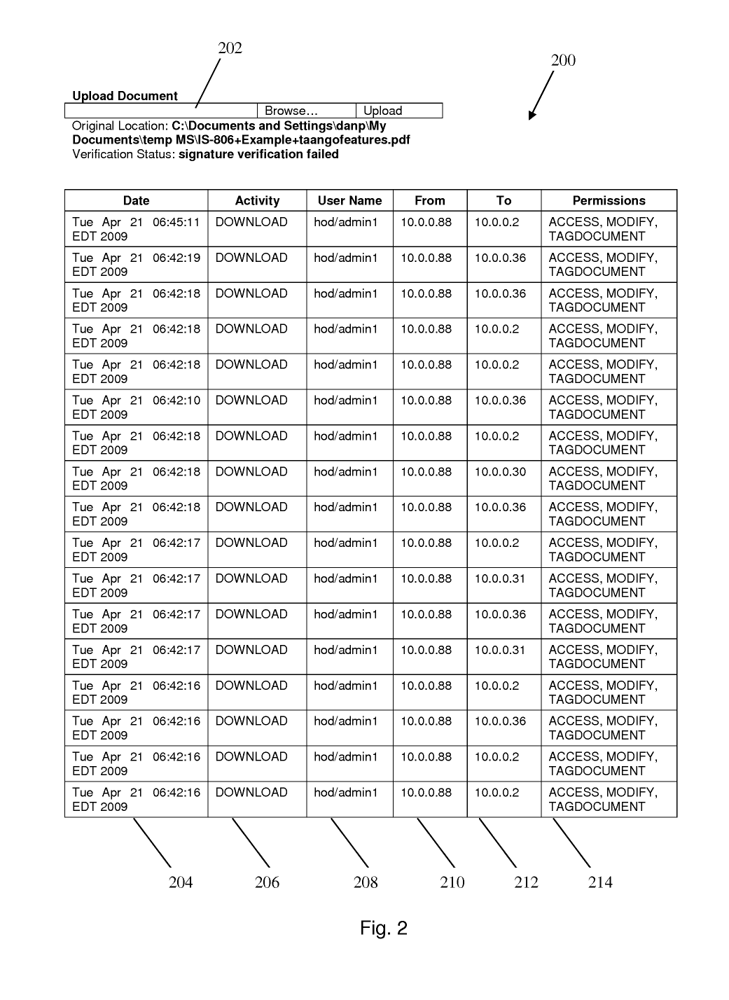

Reference is made to FIG. 2, which is a schematic illustration of data in a graphical user interface 200, in accordance with an embodiment of the invention. Graphical user interface 200 includes field 202 to identify a document path and to view a log of the document activities. The log may be encrypted and included in a document tag, for example, in metadata embedded in the document, as described above. The log may include field 204 listing the date and time of each document activity, field 206 listing the activity executed on the document, field 208 listing the user name that instructed the activity, field 210 listing the source of a document transmission (“From”), field 212 listing the destination of the document transmission (“To”), and field 214 listing the permissions of the document security policy at the time of the listed action (e.g., “access document”, “modify document”, “tag document”, etc.). According to some embodiments of the invention, the tag may include some or all of the usage history of the document. For example, the tag may include all uploads/downloads of the document, by which user, and under what conditions up until and including the last download based upon the most recent request. In some embodiments, the tag may include a log of actions on the document limited by the number of actions, e.g., single last action, or limited by the time of the actions, e.g., the last month.

Reference is again made to FIG. 1, in some embodiments of the invention, a security policy may mandate that the document may be checked out with a “remote tracking” feature. In this embodiment, remote tracking code may be embedded in the metadata of a tagged document, for example, as an executable code or as a set of instructions to the native application. For example, the remote tracking code may include instructions to remotely report document activity from user computer 8 to security server 4, for example, using an automatically-generated communication transmitted over a network. The remote tracking instructions may be executed by the native application in which the document is accessed, for example, Adobe Acrobat on a remotely tracked PDF document. Alternatively, in some native applications that may not inherently support such remote tracking, a plug-in application in the native application may be used to read and execute the remote tracking instructions.

The remote tracking instructions may cause the executing application to initiate a communication over network 10, for example, by opening a port, or via Microsoft Outlook or another network 10 application. The remote tracking instructions may include the IP address of the report destination device, e.g., a network administrator computer and/or security server 4. An email or other network communication may be sent from the user computer 8 where the document is located to the IP address designated in the remote tracking instructions. The communication may report the current location of the document, trigger activities that have been executed on the document as defined in the instructions, the date and time of the activities, etc. The remote tracking code may enable a network administrator to know when and where the tagged document has been accessed, edited, modified, printed, etc. In some embodiments, the remote tracking may be installed only to notify of prohibited activities. In some embodiments, prohibited activities may be determined by comparing the notification with the security policy of the document at the time it was downloaded to determine whether the activity was permitted.

The remote tracking code may be implemented in a variety of ways, depending on the type of document. In one example, an Adobe Portable Document Format (PDF) document may be embedded with a JavaScript remote tracking code. For example, based on JavaScript version 1.5 of ISO-16262 (formerly referred to as ECMAScript), JavaScript in Adobe Acrobat software may implement objects, methods, and properties that enable manipulation of PDF files. According to some embodiments of the invention, the remote tracking code may be Acrobat JavaScript code embedded into a PDF document initiated by a document activity on remote user computer 8, for example, an open command, a save command, a print command, etc. The JavaScript code may initiate network 10 communications, for example, generating a message from the remote user computer 8 to the report destination device notifying the device of the document activity.

According to an embodiment of the invention, security server 4 may be installed to intercept all communications between shared document servers 6 and user computers 8. In some embodiments of the invention, the security server 4 may be operatively associated with an email server, such that the above actions may be taken by or in concert with the email server, for example, a Microsoft Exchange server. Thus, an email having a document attached thereto may be intercepted at the Microsoft (MS) Exchange server, which may have embedded therewithin a tag or remote tracking code. The attached file, e.g., a PDF file, may be processed by the core platform according to the set of security levels defined for the document and the user. Based on the policy, the document may be modified to include a tag or a remote tracking code, as described above, to enables the file to remotely register itself when defined activities are taken. For example, in the case of a PDF document, usage events, created by a user interacting with the document using Acrobat Reader or Acrobat, may include opening, printing, modifying, saving, etc., and notification of such may be forwarded by network communication and/or email from within the Acrobat Reader to the destination IP address designated in the remote tracking code. Therefore, when a classified PDF is opened on user computer 8 from anywhere in the network 10, the Acrobat software may recognize the Adobe-approved, cryptographically signed document permissions tag including the remote tracking code. Subsequently, the Acrobat Reader software may execute the remote tracking code instructions within the document permissions tag to open a TCP/IP-based Simple Object Access Protocol (SOAP) connection, e.g., over port 80 or port 443, to the report destination device IP address.

The Acrobat software may execute the remote tracking code instructions to transmit a remote tracking report to the report the document activity to the report destination device. The activity report may include, for example, a document identification number, a current document activity, that is, “OPEN,” a usage history or chain of custody included in the document permissions tag, a user name or user identification code or password, and/or the IP address of the user computer 8 on which the document is opened. If network 10 is unavailable, the activity report may be written into the document permissions tag for transmission at a later time when a network 10 connection is made.

In an example in accordance with an embodiment of the invention, a user may disseminate a document via the email server by forwarding the document via Microsoft (MS) Outlook via MS Exchange. For example, the sender may send a file to the email account of another user in the system as an attachment in an email. The MS Exchange server may receive the email message with the attachment document. The MS Exchange server may determine based on the above principles and embodiments of the present invention whether or not to attach a tag, remote tracking code, etc., and whether the security policy for the document should be updated based on the user receiving the document, etc., for example, based on the content of the document, if modified since the document was downloaded.

An MS Exchange plug-in may be used according to embodiments of the present invention to search document attachments of email messages, sorting through and isolating attachments that match criteria for embedding a tag and/or remote tracking code. Once a candidate file has been found, the plug-in may inventory the file into the core platform, insert the document permissions tag, update the document permissions tag with the official chain of custody with the available metadata of the sender and the recipient, e.g., email address, time, etc. The plug-in may update the document permissions tag with the document's policies, including the remote tracking code, along with the network communication information of the report destination device IP address. The plug-in may replace the original document attachment with the modified (tagged) version in the Exchange server's email queue. The MS Exchange server may then send the email message including the tagged attachment to the report destination device IP address.

A receiver at the report destination device IP address, e.g., a network administrator, may open the file directly from within the email client. Alternatively, the receiver may save the file to a local computer and open the file using a supporting application, e.g., Adobe Acrobat Reader version 7.0, etc. When the Acrobat Reader opens the document, the Acrobat Reader may detect the Adobe-enabled document permissions tag, including for example, the remote tracking code embedded in the document. The Adobe Reader may process the instructions in the document permissions tag for each reported document activity, for example, as described in the included document policy setting.

According to embodiments of the invention, the remote tracking code may instruct the Acrobat Reader to securely transmit a document activity log to the report destination device, e.g., using a Secure Sockets Layer (SSL)-signed communication protocol. The document activity report may include, for example, a document identification number, a current document activity, that is, “OPEN,” a usage history or chain of custody parameter or information included in the document permissions tag, a user name or user identification code or password, and/or the IP address of the user computer 8 on which the document is opened. Subsequently, any other document activity may be logged by the document permissions tag and transmitted to the report destination device, for example, using Adobe-enabled functionality executed by the Adobe Acrobat Reader. According to embodiments of the invention, an administrator may monitor and report remote usage of the tagged document on a remote user computer 8. For example, the administrator may generate tabular reports, for example, using a simple web browser, and/or using analytics to perform calculations and other analysis on the data.

Although in the description above, document policy settings were described as generally based on the content of the document and/or the user requesting the document, according to some embodiments of the invention, the document policy settings may be based on additional parameters, for example, (i) a specific document regardless of the security level of a user requesting the document; (ii) a specific user regardless of the security level of the document; (iii) a group of related documents regardless of the security level of the user requesting the document, (iv) a group of users requesting the document regardless of the security level of the documents; (v) a user role regardless of the security level of the documents, e.g., an executive, director, administrator, etc.; (vi) a combination of the aforementioned options, etc. These parameters may define the document policy settings of the documents in shared document server 6. These parameters may be referred to, for example, as “corporate policies”, and may be set by a network administrator. The administrator may use a graphical user interface operating a security server 4 module, e.g., in a Web 2.0 browser, to encode document policy setting for documents in shared document server 6. In another embodiment of the present invention, authorized users may customize document policy settings. In this embodiment, the customize document policy settings may not interfere with corporate policies, which remain active regardless of the customized document policy settings by authorized users.

Thus, for example, a corporate policy may read, “Authorized recipients of research division may open, print, and save the PDF file, but are not permitted to forward the document to any other user. Printed documents must have the document permissions tag in the form of a matrix code (two-dimensional bar code). Permit authorized internal sales team members to allow an authorized recipient to forward the file to any other user, but any unauthorized recipient can only view the file for 24 hours upon receiving it and cannot print or save the document. All usage by both authorized and unauthorized users is logged remotely to the security server: no exceptions.” In this example, the user delegates printing for the unauthorized user without remote logging of this usage event. In this example, the security server 4 may automatically override the customized document policy settings by authorized users, log the customize document policy settings attempt to the event log, and enforce the corporate policy settings.

Reference is made to FIG. 3, which is a flow diagram of operations according to an embodiment of the present invention. It will be recognized that some embodiments of the invention may include all, or some but not all of the modules and functionalities described in connection with FIG. 1. Embodiments of the present invention may include either or both of an initial “discovery” stage and/or an ongoing “continued” stage.

Operation 100 may include an initial (discovery) stage. In the discovery stage, security server 4 may “discover” documents stored in shared document server 6. When the security server 4 is first installed, security server 4 may scan the entire contents of shared document servers 6 to catalogue and index storage of each document therein. Each document may be represented by a record in security server 4 including fields, for example, representing a unique document identification, the date the document was created, the date the document was last modified, the date the document was last accessed, the user(s) that generated the document, the type of document, the document size, a document hash code, e.g., based on the document content, and/or other document data, etc.

Operation 101 may include classify the documents discovered is operation 100. Based on some or all of the document record data, a process may proceed to classify discovered documents using classification rules. The classification rules may be defined by a network administrator. The rules define document security levels, confidentiality, sensitivity and/or accessibility functions. The accessibility functions input metadata for each discovered document and output a security level, default document policy setting, and/or classification for the document. For example, a rule may define that spreadsheet documents created a user in an accounting group of an enterprise within the past 12 months may have a document security level of 8 out of 10.

One type of output of operation 101 may define a document policy setting. For example, the spreadsheet documents described above may be accessed by anyone in the accounting department as well as any officer of the company, but only the chief financial officer may modify the documents. Other variations are possible within the scope of the invention. Types of permissions of a document policy setting may include the permission to access/open the document, change/modify/write the document, send the document to a remote location, for example, outside the computing network 2 via email, store or save the document on a local user computer 8, delete the document from shared document server 6, set an expiration date for the document, delegate the aforementioned access another user, display the document on a display on user computer 8, print the document, etc. One, some, or all of these permissions or restrictions may depend on a user, a group of users, a location of the operation, for example, within the organization, from home, from a public computer, over a wireless connection, etc.

Operation 102 may include tagging the discovered documents based on the classification of the document policy setting of a document in operation 101. Each document may be associated with a document permission tag that defines the terms of permissible and/or impermissible use of the document. According to some embodiments of the invention, the document permission tag may be stored in a security server 4. The document permission tag may be associated with each document, for example, by a document identification code, tag, or other identifier. Since the content of documents in shared document server 6 may continually be changed by users, security server 4 may continually or periodically discover, classify, and tag documents in this second (continued usage) stage of embodiments of the invention.

Operation 103 may include monitoring user computers 8 that access documents from shared document servers 6. In one embodiment, security server 4 may include a document retrieval module to which user computers 8 may send a document request. The document retrieval module may include a user interface, or may be include in an application programming interface (API) interfacing directly with the application requesting the document. Accordingly, when user computers 8 requests a document from shared document server 6, for example, to access or delete the document, security server 4 may compare the document request to the permission tag of the document to determine whether or not to permit the request.

Operation 104 may include detecting authorized and unauthorized document activity stored in the document permission tag. For example, a request to access a document may be either permissible or impermissible.

Operation 105 may include warning a user or administrator. In some embodiments of the invention, some actions may be regarded as “suspect”, for example, permitted with a warning flag. A cumulative number of suspect actions exceeding a predetermined threshold may result in an impermissible action. Operation 105 may further include logging document activities by users or user computers 8 in a log file. Impermissible and/or suspect activities may result in a warning or notification to an administrator.

Operation 106 may include acting, for example, automatically, to protect the system against violations, e.g., by deleting corrupted documents, restoring original versions, etc. The system's automated actions may be integrated with usage management.

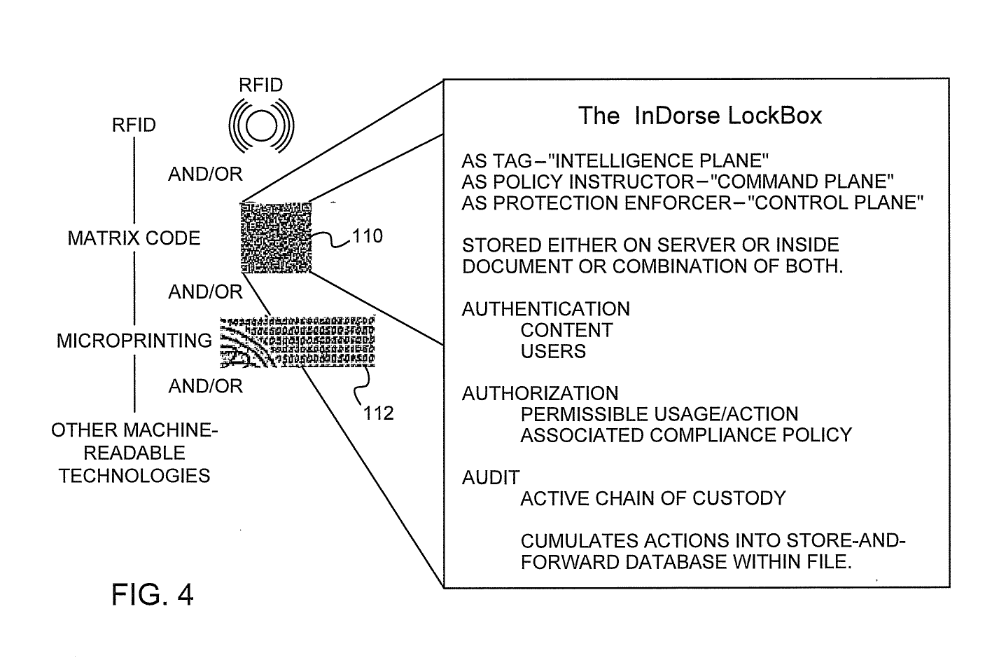

Reference is made to FIG. 4, which is a schematic illustration of a certain implementations or visualizations of a document permission tag, according to some embodiments of the present invention. The document permission tag may be generated based on the document upon the classification operation, as described above in reference to FIG. 3.

Tagged documents may include machine-readable content embedded directly within the native document format itself, for example, as signed and encrypted metadata. In some embodiments, security server 4 may store a copy of the document permissions tag or data associated therewith for each managed document. The document permissions tag may be updated, for example, when document policy settings are updating, i.e., for each document request, upload or download of the document to or from shared document server 6.

In some embodiments of the invention, documents may be stored in shared document server 6 in a native format, and the associated document permissions tags may be stored separately, e.g., in security server 4. When a user requests access to a document, for example, to check a document out of shared document server 6, if the requested action is permitted based on the document policy setting associated with the document, the user security level, and/or the circumstances of the request, security server 4 may embed the native document with the permissions tag into a metadata field of the document. The tagged document may be sent to the requesting user for use.

The document permissions tag may include information including but not limited to: a parameter indicating the content of the document, for example, a hash code based on document content or size; a number of authorized users; the user to whom the document is checked out; a document authorization, for example, permissible and/or impermissible usage or actions for the document; a compliance policy; an audit parameter, for example, a chain of custody or usage history that lists users who have previously received and/or accessed the document.

In some embodiments of the invention, the document permissions tag may be embedded into the document as plain text or as a coded text field in the information field of the document metadata. For an image document, the document permissions tag may be encoded and imprinted onto the image document itself, for example, as a two-dimensional (2D) barcode 110 and/or may be microprinted 112 thereon. Accordingly, when the document is printed, 2D barcode 110 and/or microprint 112 permissions tag may likewise be printed. In some embodiments of the invention, a 2D barcode 110 and/or microprint 112 may be automatically inserted into a document, e.g., into the header or footer of a text document, such that it appears when the document is printed.

A document having a document permissions tag printed thereon according to embodiments of the present invention, may be inspected and decoded to establish document authenticity. For example, upon presentation of the document, the document content parameter stored in the document permissions tag may be retrieved. A matching document content parameter may be determined with respect to the document presented for authentication. If the two document content parameters are identical, it may be established that the document as originally provided to a user is identical to the document being presented for authentication, and therefore, the document presented is authentic. In some embodiments of the invention, the document content parameter may include a check on the document metadata, including at least the document permissions tag in order to establish that the document permissions tag has not itself been tampered with. The document permissions tag may provide certification and authentication of documents in a portable, modular way, serving as the “certificate of authenticity” of (a) author non-repudiation, (b) content integrity, (c) certified audit trail of users possessing the document, and (d) policies that govern acceptable usage of the document by authorized users wherever they may access the document.

It will be reiterated that in some embodiment of the invention, the documents are stored in their native format in shared document server 6. Upon being requested by a use, for example, manually, or by an application, e.g., email, security server 4 receives the request, retrieves a document policy setting or permission tag associated therewith, compares the document policy setting to the request, e.g., user security level, user location, requesting application, etc. If security server 4 determines that the request is acceptable, security server 4 embeds the document permissions tag into the document itself. The security server 4 provides user computer 8 with the tagged version of the document.

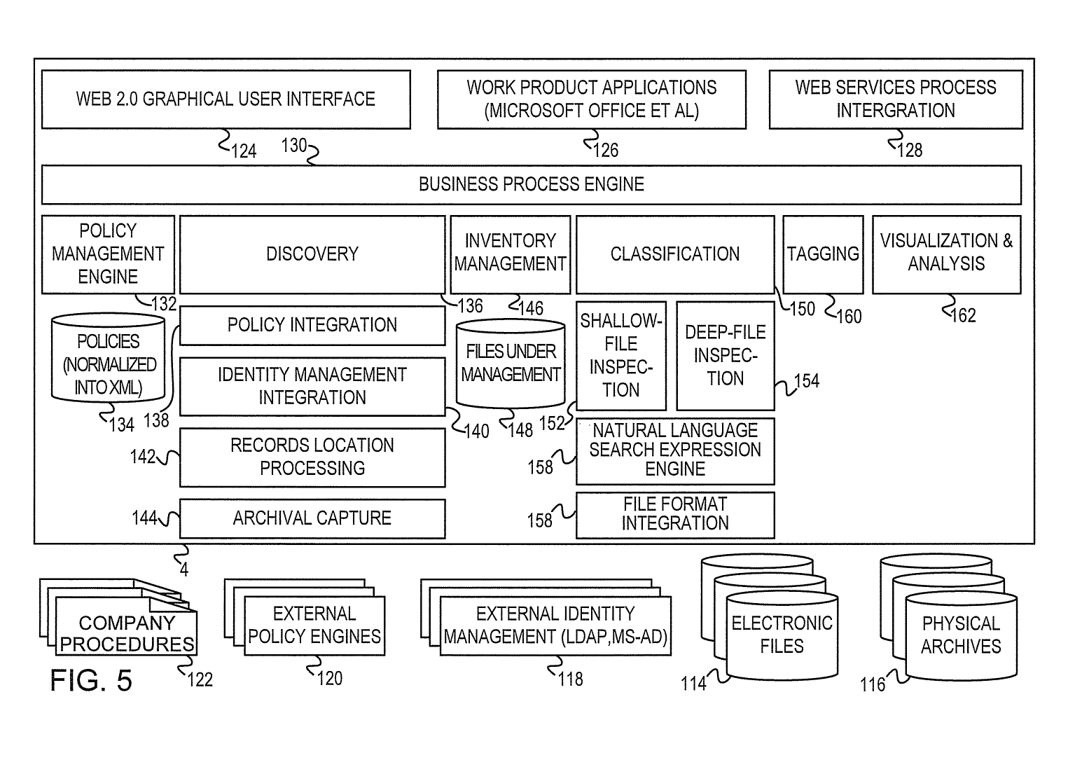

Reference is made to FIG. 5, which is a schematic illustration of a security server in accordance with embodiments of the present invention. The security server may be security server 4, as described in reference to FIG. 1.

Security server 4 may be installed to intercept all communications between shared document servers 6 and user computers 8. Security server 4 may provide document security management for distributing documents from shared document servers 6 throughout computing network 2. Security server 4 may be installed and integrated as an intermediary device intercepting and managing communications between shared document servers 6 and user computers 8. User computers 8 computing devices, e.g., desktops, servers, laptops, and mobile PDAs, etc., each of which run current applications tools, e.g., Microsoft Office, Visio, Outlook, SharePoint, and Adobe Acrobat PDF.

Security server 4 may include an application server with a plurality of operably communicating modules, which executed by a processor provide functionality according to embodiments of the invention. Security server 4 may be in operative communication with document in shared document servers 6, for example, electronic files 114 and/or physical archives 116, an external identity management 118, external policy engines 120, and/or a set of company procedures 122. These may be managed by the enterprise or company or by any third party service provider, for example, an information security company.

Security server 4 may have a user interface module 124, for example, a graphical user interface to provide user computers 8 with access to documents in the shared document servers 6. Security server 4 may include application programming interfaces (APIs) module 126 to interface with work product applications, e.g., Microsoft Office and other applications. Security server 4 may include web services process integration module 128 to communicate with other computers or applications over network 10, such as the Internet.

Security server 4 may include a business process engine module 130 may manage and coordinate processes of the aforementioned modules.

Security server 4 may include a policy management module 132 to manage document policy settings 134 for accessing documents, for example, using Extensible Markup Language (XML), Extensible Stylesheet Language (XSL), etc. The document policy settings may be stored and/or retrieved from a policies data storage, e.g., within or separate from security server 4.

Security server 4 may include a discovery module 136 to discover, review and tag documents, for example, as described in reference to FIG. 3. Discovery module 136 may include sub-modules such as policy integration module 138, identity management integration module 140, records location processing module 142, and archival capture module 144.

Security server 4 may include an inventory management module 146 in conjunction with a data storage of an index of files under management 148 may keep track of files existing, created, deleted, their location, and other information.

Security server 4 may include a classification module 150, which include a shallow-file inspection sub-module 152 and/or deep-file inspection sub-module 154 on discovered documents to establish their sensitivity, for example, as described in reference to FIG. 3. Shallow-file inspection sub-module 152 may classify documents based on a set of simple or discrete classification rules, for example, as described in reference to FIG. 3. Deep-file inspection sub-module 154 may use heuristics and other tools to classify documents based on more complex criteria. Sub-modules including natural language and/or search expressions sub-module 158 may search the documents and file format integration sub-module 156 may discern file formats and access content of files in various formats.

Security server 4 may include a tagging module 160 to create document permission tags for classified documents. These may be stored in a database of document permission tags, and/or may be embedded in the files themselves.

Security server 4 may include a visualization and analytics module 162 to provide an administrator with information about the types, classification, usage, etc. of documents under management.

Other or different component, modules, and functionalities may be provided according to embodiments of the present invention.

Applications according to embodiments of the present application may store document permissions tags, e.g., in security server 4 and may embed the document permissions tags in the document as encrypted metadata.

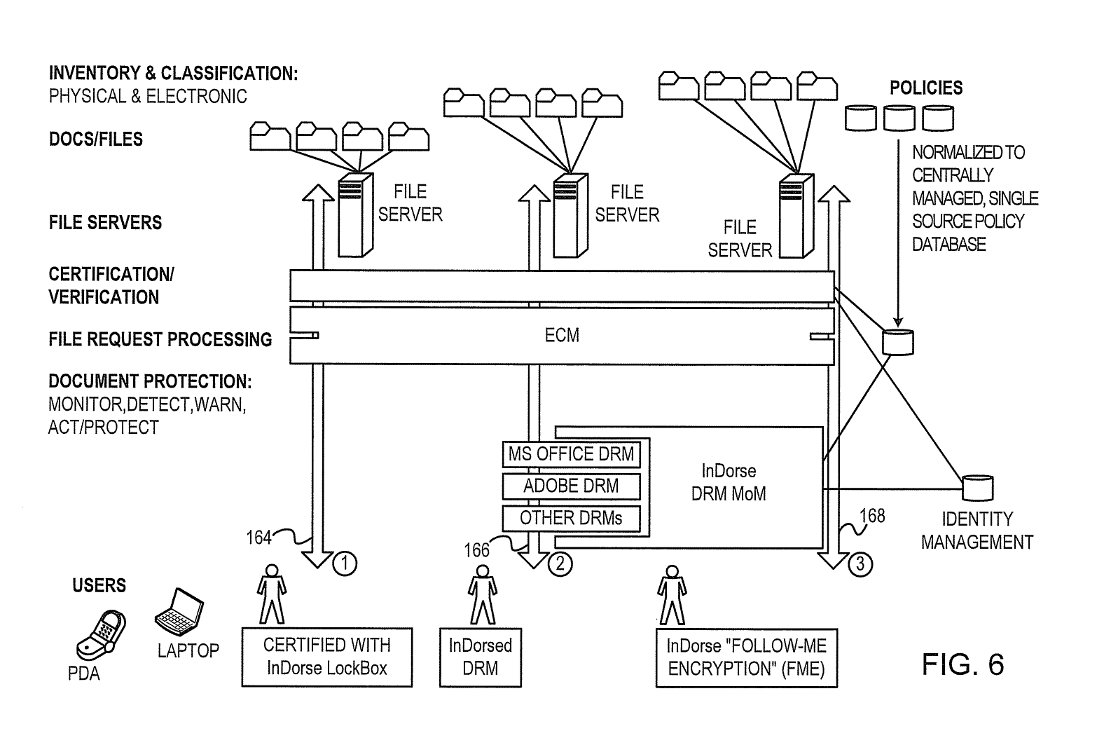

FIG. 6 is a schematic illustration of applications interfacing with the computing network of FIG. 1 to provide document security management in a shared network according to embodiments of the present invention.

The computing network may use web service infrastructure and security event management systems, for example, and/or enterprise content management (ECM), to warn an administrator of unauthorized usage, for example, on an exception basis.

Shared document server 6 may include documents with confidential content, such as, financial checks, sensitive files (e.g., spreadsheets, text documents, Hypertext Markup Language (HTML) or wild entries), company identification cards and human exchangeable documents, which may require high levels of security assurance. Security server 4 may use a processor to run applications to execute software modules, for example, described in reference to FIG. 5. The modules may be operate independently or may be coordinated and integrated, e.g., by business process engine module 130, such as Microsoft SharePoint's Workflow Foundation Services, to run together.

Operations path 164 may tag documents. According to embodiments of the invention, applications may authenticate documents using document permissions tags. The document permissions tags may be used to authenticate any or all of the following document metadata: (i) identity proof of trusted authors and recipients/users, (ii) integrity check of document content or text, (iii) permissible, acceptable activities (access, modify, print, storage, transmission, expiration), and (iv) “chain of custody” audit train which stores activity executed with the document and is automatically updated when users access the document.

As discussed above, the document permissions tag may store metadata and security information according to a document policy setting, which may define user-specific and/or document-specific restrictions and permissions for the document. In some embodiments, a minimum set of metadata may be embedded in the document when the document is first generated and may remain embedded throughout the document's lifecycle. This metadata may include, for example, non-repudiated proof of author, whitelist of authorized users, blacklists of unauthorized users, greylists of semi-authorized users, and integrity proof of actual content. Other additional metadata, for example, permission tags, tag logs, etc., may be embedded and removed from the document, e.g., each time the document is checked out and in of shared document server 6, respectively.

Operations path 166 may secure documents. Security server 4 may interact with a digital rights management (DRM) engine. Security server 4 may direct a requested document and the document policy setting stored within the document permissions tag to the DRM engine. A permissions tag for a document may include the DRM deployment setting. The DRM setting may include, e.g., user, user type, current user location, current user access device, time and date, etc. The DRM engine may determine a corresponding DRM setting for the document based on the policy setting. The DRM engine may then convert and secure the document according thereto.

The DRM engine may convert the document into the proper application format of the executing application and may deliver the document to the requesting user with the appropriate level of security strength as defined by the document policy setting. The specific operating DRM engine may be seamlessly interchanged or replaced with a new DRM system without the need to convert the document policies again. Thus, the operations path 164 may provide a uniform interface to produce respectively different DRM outputs by interchanging DRM engines as appropriate for the documents under management.

If no DRM engines are available, or the document policy setting requires documents to be delivered without using encryption or complex public key deployment, operations path 168 may be used.

Operations path 168 may provide reports to maintain network security. Security server 4 may provide documents with follow-me encryption (FME). FME secures documents in a manner similar to hard drive encryption, which is known. An FME secured document may be accessed by authorized users from any or authorized user computers 8 allowed by the document policy setting. Operations path 168 may enforce and report against policies which require documents from shared document server 6 to be delivered and encrypted with the requesting user's credentials, e.g., password, one-time-password (OTP), ID card, or biometrics.

Document permissions tag may include instructions that when executed by a processor cause the requested document to be retrieved from shared document server 6.

Follow-me security system (FMS) may be used including FMS plug-ins located on user computers 8 and FMS module on security server 4. The FMS plug-in on an authorized user computers 8 may request a document from security server 4 to retrieve a document from shared document server 6. The FMS module on security server 4 may (a) intercept the request, (b) access the document from a file store by conventional file access methods (e.g., Common Internet File System (CIFS), SAMBA, WebDAV, etc.), (c) securely extract the document permissions tag, (d) update the access audit log with the proof of the authorized user (i.e., an electronic “chain of custody”), (e) check expiry of document policy setting against the policy engine (the Policy Management Engine, Microsoft Active Directory, or any other suitable policy management system), (f) search the document permissions tag for the appropriate access or document policy setting based upon the authorized user request metadata (e.g., the location of the user, user group/role, user device type, etc.) and (g) assess any conflict between the document policy setting and corporate policies.

If the document policy setting requires, the actual document from shared document server 6 may be delivered in one of the following formats: (a) in the clear, e.g., not encrypted, but delivered to the user with the document permissions tag including an updated “chain of custody,” (b) encoded with a particular business-defined DRM format (Microsoft, Adobe, Liquid Machines, etc.), or (c) encoded with a “lightweight DRM,” Follow-Me-Encryption (FME). For the delivery choice (b), the FMS may serve as a “manager of managers” (MoM) for the DRM engine. The FMS may distribute the document policy setting to the DRM engine to secure each document. Accordingly, for example, the FMS may rely on the DRM engine to convert the general policy setting to the DRM's specific application protocol interface (API) for implementation, and the DRM engine may then return the protected document to the FMS, which in turn would tag and deliver the document to the requesting end user. Thus, the document policy setting may be stored in one location. This enables DRM engines to be interchanged without any loss of data and/or management effort. In addition, the DRM MoM may execute policy management instructions separately from rights management and enforcement instructions.

Some embodiments of the invention may enable authorized users and groups of users having an authorized role to delegate document permissions for trusted users outside the computing network 2, e.g., for a partner or affiliated group outside the company network.

Based on the above description of the system according to the present invention, various functionalities are possible. For example, the security server may mediate between the shared document server and an email server, such that any request by a user to attach a document to an email message must be approved by the security server, which in turn, may rely on the content- and/or context-based, classification and policies determined by the security server, as discussed above. The security server may cause a document tagging module to tag the document with a document permissions tag before providing the document to the email program for attachment. In some embodiments, the system of the present invention may determine that the document is not to be attached to an email, and may refuse to provide the document to the email application. In some embodiments, the system of the present invention may initiate a message, e.g., via email, wireless, SNMP, web or- services-based, etc.) to a report center notifying an administrator of the attempted or executed document use. According to embodiments of the present invention, a tag inspection application may be associated with a security server, which may inspect every incoming and outgoing message, particularly with respect to attachments. A document attached to an outgoing email may have a document permissions tag associated with it. Accordingly, when the email is intercepted by the tag inspection application of the present invention, the document permissions tag may be inspected, and it may accordingly be determined whether the action performed by the user, e.g., sending the document to a person outside the organization is permissible based on the document permissions tag, is permitted. If the action is not permissible, the email message may be returned to the sender, and a notification provided to the administrator. In some embodiments of the invention, a field of the document permissions tag may require that a document being emailed outside the organization be restricted. Based on such a tag, the tag inspection module may modify permissions of the document (e.g., read only), or convert it to a suitable form (e.g., Adobe PDF) and send the modified or converted restricted document to the email recipient. With respect to incoming messages, attachments may be inspected and tagged similarly as in the discovery stage of the present invention. Thus, when the document arrives at the user, and/or when the user requests to save the document to shared document server 6, the database of the document permissions tag may be updated accordingly.

Another example of a functionality of the system of the present invention is establishing a chain of custody of a document. As described above, a cumulative chain of custody of a document may be embedded in the document permissions tag. Thus, an application capable of reading the document permissions tag may read the chain of custody of a document and present the information visually, for example, as a timeline, or a vertical tree. The chain of custody may further reflect one or more other documents related to the genealogy of a document, for example, a document from which the present document was copied, and the time of the copying. Thus, the document history may trace back to the point of origination of the derivative document and continue with the history of the original document at the time the derivative document was copied. It will be recognized that in some embodiment of the invention, the document permissions tag may store only a predetermined number of links in the chain of custody, and that a full chain of custody may be obtained from by reconstructing the history from log files of the system. Furthermore, using the chain of custody feature, documents that have common origins as instances of copies of an earlier generation file may be isolated and reported as a group. Such detection may then be used by the security server to assign the stricter of the policies associated between an earlier generation of the file or the file for which the user requests access.

According to an embodiment of the invention, a content object, e.g., a digital image, a text document, a multimedia content object, a document, a file, or any other content object provided to a user computer may subsequently be communicated to another user computer and/or to any other computer over a data network. For example, one of user computers 8 may receive a file, e.g., from security server 4 as described herein and may forward the file, e.g., in an email or otherwise, to another one of user computers 8, or to any other computer, e.g., over the Internet. Likewise, or in addition, a content object provided by server 4 to one of user computers 8 may be duplicated and stored on a number of computers. For example, one of user computers 8 may receive a file from server 8, and may forward the file to a number of mail recipients, who may each store a copy of the file on a storage media, or they each may upload the file to a web site, e.g., a web site related to sharing of content. Accordingly, a content object provided by server 4 may be stored on any applicable storage system, e.g., anywhere on the Internet, or on a client device connected to the Internet. For the sake of simplicity, the discussion herein will mainly refer to files; however, it will be understood that the invention may be applicable to any content object, e.g., documents including text, images or other content, multimedia objects such as video clips or images, etc.

As referred to herein, a chain of custody of a content object may refer to any parameter, data or other information related to who currently or previously possesses or owns a copy of a content object (e.g., a name of a person, an email address, an IP address, etc.), and/or actions or operations performed on or with relation to the content object (e.g., open, modify, delete, play, etc.), and other circumstances of such actions or operations. For example, chain of custody information may include information related to time-related information (e.g., when a file was delivered, opened or modified) and/or location-related information (e.g., where a file is stored, an IP address of a storage server). As discussed herein, execution of an executable remote tracking code in a tag may cause transmission of chain of custody information to a server, which in turn, may generate a report based on such information. A report generated by a server may additionally or alternatively be according to a tag identified by a crawler in a content object stored on a remote storage system, e.g., any storage system other than a predefined, known, original or otherwise specific storage.

According to embodiments of the invention, an application, a program and/or a process may be executed by a hardware device (e.g., a server or a plurality of computing devices) to obtain chain of custody information related to content objects. As described herein, obtaining chain of custody information may be according to various configuration parameters. A web crawler may perform operations described below. Generally, as referred to herein, a web crawler, or crawler, may be one or more software programs that automatically traverse the Web. A crawler may brows a network such as the Internet or a private network in a methodical, automated manner or in an orderly fashion. A Web crawler according to the present invention may obtain a copy of visited pages and/or content objects retrieved from a network and may process obtained content objects. For example, a tag may be searched for in content objects. A tag may be or may include any digital information, data, executable code or parameters that may be included in a content object, e.g., an encrypted code may be included in a file such that it is part of the file's content.

For example, the set of pixels included in an image file may be modified, e.g., by removing some of the pixels, adding pixels and/or changing pixels' attributes or values. For example, an invisible tag (e.g., a watermark) may be added to a digital image and may only be discovered and/or identified by a computing device executing specialized executable code. A crawler may examine content objects embedded in content objects. For example, a Word document may include an image (e.g., embedded in the document), other examples may be compressed volumes. A crawler may examine a first document, identify embedded content objects and recursively examine all embedded documents. Accordingly, a tag included in a first content object that itself is included in a second content object may be identified by a crawler according to embodiments of the invention.

A tag may be included in metadata, e.g., inserted into a metadata field associated with the content object. A tag may be encrypted prior or after being associated with a content object. For example, digital content objects often have one or more metadata objects associated with them. A tag may be included in one or more metadata objects. A tag included in a content object may include executable remote tracking code configured to transmit information related to operations performed on, or related to, the content object. For example, information transmitted may a chain of custody information and/or report.

According to an embodiment, prior to delivering a content object from a first storage (e.g., server 6 or server 4), the content object may be associated with a tag by including the tag in the content object or by including the tag in metadata associated with the content object. A tag associated with a content object may be processed or updated according to any parameter or aspect related to a delivery of the content object. For example, server 4 may record the IP address of the computing device to which the content object is delivered, the time and date of delivery, parameters such as a data integrity code etc. Any information referred to herein as chain of custody information may be included in a tag inserted into, or otherwise associated with a content object.

As described herein, the content object may be duplicated and/or forwarded to a number of destinations and may, given time, be present on at least a second storage (e.g., a web site's storage). A web crawler may examine content objects stored on the web site (the second storage in the above example), may search for one or more tags in examined content objects and, upon determining a content object includes a tag, perform one or more actions. It will be understood that a crawler as described herein is not restricted to examining content on web sites, a crawler may examine any content retrieved from any storage, e.g., inside an organization, in a private network etc.

According to embodiments of the invention, a crawler may examine content objects based on any number of configuration parameters, rules, thresholds or criteria. For example, a uniform resource locator (URL), a domain name, specific metadata information related to a content objects or a list of content objects to be examine may be provided to a crawler that may search for tags in content objects based on such provided parameters. For example, a URL or domain name may be supplied to a crawler that may examine some or all files or content on a web site pointed to by the URL or a domain referred to in a provided domain name. In another example, a storage system of an organization may be examined, a list of some or all files may be made and a crawler may be provided with such list. In such case, the crawler may report any copy or instance of documents in the list found on remote storage systems, e.g., in a specific internet domain or web site. For example, any instance

Any criteria, rule or configuration parameter related to the storage location (e.g., through a URL or IP address) or to the content object itself may be used by a crawler to search for tagged content objects. For example, a crawler may be made to search for tagged content objects according to, or based on, a file type, a keyword, a file name, a file size, an IP address, or link received from a web site and a list of previously located content objects. For example, a tag may only be searched for in files larger than a specific size, or in files containing a specific keyword etc. Alternatively of additionally, only files found at a specific IP address may be examined.

Upon detecting a tag, a crawler may perform one or more actions. Operations performed may be related to the content object. For example, the crawler may delete or remove the content object from the storage on which it was detected. The crawler may modify the a tagged content object based on rules or criteria provided and/or based on information in the tag. A crawler may process or modify the content object and/or modify an attribute of the content object. A crawler may process or modify metadata associated with content object, e.g., modify write permissions, modification date and time, the name of the content object, validate an integrity of information included in the content object, etc. A crawler may send the content object to a server and/or provide a server with any other information, for example, the crawler may send the tag to a server and additional information, e.g., information related to the storage on which the content object is stored, the time and date the content object was identified as a tagged object etc. An action performed by a crawler may be based on, or according to, a parameter related to a storage, a parameter related to the content object, a preconfigured parameter provided to the web crawler or metadata associated with the content object. An action may be according to a usage history of the content object or a security parameter associated with the content object.

In some cases, it may be inefficient to provide a crawler or a set of crawlers with an entire set of configuration rules, criteria or policies. Accordingly, a table or list may be maintained on a server. An entry in a list or table may include at least a content object identifier and a tag identifier. The list or table may be updated upon delivery of the content object. For example, server 4 may update such list when updating a tag upon delivery of a content object. Upon detecting a tag in a file, a crawler may send the tag or part thereof to server 4 that may, using the table, identify the content object and possibly, associated security or other information. Server 4 may determine an action needed, e.g., a modification to made to the content object detected by the crawler and may instruct the crawler to perform the necessary action. In other cases, a crawler may determine or select an action to be performed without first receiving information or instructions from a server.

It should be recognized that embodiments of the present invention may solve one or more of the objectives and/or challenges described in the background, and that embodiments of the invention need not meet every one of the above objectives and/or challenges to come within the scope of the present invention. While certain features of the invention have been particularly illustrated and described herein, many modifications, substitutions, changes, and equivalents may occur to those of ordinary skill in the art. It is, therefore, to be understood that the appended claims are intended to cover all such modifications and changes in form and details as fall within the true spirit of the invention.

What is claimed is:

1. A method of tracking digital content objects, the method comprising:
associating a content object with a tag prior to delivering the content object from a first storage;
examining, by a web crawler, content objects stored on a second storage and determining at least one content object includes the tag; and
performing at least one action based at least in part on information included in the tag.

2. The method of claim 1, wherein the tag includes a remote tracking code configured to transmit information related to operations related to the content object and wherein the at least one action includes generating a chain of custody report based on information transmitted by the remote tracking code.

3. The method of claim 1, wherein associating the content object with a tag prior to delivering the content object from the first storage includes updating information included in the tag according to the delivering of the content object.

4. The method of claim 1, wherein the action includes at least one of operation selected from the list consisting of: modifying the content object, modifying an attribute of the content object, removing the content object from the second storage, sending the content object to a server, validating integrity of information included in the content object, more

5. The method of claim 1, wherein the tag is embedded in a first content object and wherein the first content object is embedded in a second content object.

6. The method of claim 1, wherein examining content objects stored on the second storage is based on at least one parameter selected from the list consisting of: a uniform resource locator (URL), a domain name, metadata related to the content objects, a list of content objects, a file type, a keyword, a file name, a file size, a list of files to be located, an IP address, a link from a website and a history parameter.

7. The method of claim 1, wherein the at least one action is based at least in part on one of: a parameter related to the second storage, a parameter related to the at least one content object, a preconfigured parameter provided to the web crawler, metadata associated with the at least one content object, a usage history of the at least one content object, a security parameter associated with the least one content object, more

8. The method of claim 1, wherein the content object is one of: a digital image, a text document and a multimedia content object.

9. The method of claim 1, wherein the tag is an invisible tag.

10. The method of claim 1, wherein the tag is inserted into a metadata field associated with the content object.

11. The method of claim 1, comprising encrypting the tag prior to associating the tag with the content object.

12. The method of claim 1, wherein the tag comprises a set of instructions capable of being read by an application used to access the content object.
